(19) United States
(12) Patent Application Publication
(10) Pub. No.: US 2016/0003466 A1
(43) Pub. Date: Jan. 7, 2016

(54) Multiple Function and Surface LED Light

(71) Applicant: Tseng-Lu Chien, Walnut, CA (US)

(72) Inventor: Tseng-Lu Chien, Walnut, CA (US)

(21) Appl. No.: 14/793,262

(22) Filed: Jul. 7, 2015

Related U.S. Application Data
(63) Continuation-in-part of application No. 14/642,169, filed on Mar. 9, 2015.
Application No. 14/642,169 is a continuation of application No. 12/950,917, filed on Nov. 19, 2010.

(51) Int. Cl. F21V 33/00; F21V 21/00

(52) U.S. Cl. CPC F21V 33/0004; F21V 21/00; F21Y 2101/02

(57) ABSTRACT

A multiple surface LED light has at least a first surface on which LED elements are arranged to provide an illumination function and at least one other surface arranged to provide other desired functions, performances, and/or features. The said LED light has a frame or housing, and an opening that allows the exposed one of the first and other r surfaces to be changed when external force is applied to the LED light.

This application is a continuation of (#CCC-1) U.S. patent application Ser. No. 14/642,169 which is Continuation filing of the application is a continuation of (#CCC-10) U.S. patent application Ser. No. 12/950,917, filed Nov. 19, 2010 (Now is U.S. Pat. No. 8,998,462), and incorporated by reference herein.

This application also is Continue filing basing on co-pending of co-pending filing for
(# UU) U.S. patent application Ser. No. 12/938,628; and
(#R) U.S. patent application Ser. No. 11/806,285 Multiple functions LED Night Light; and
(#FFF) U.S. patent application Ser. No. 13/117,227 Plug-In prong USB Charger
(#SSS) U.S. patent application Ser. No. 13/863,073 Desktop Hand reachable USB Power station; and
(#RRR) U.S. patent application Ser. No. 13/858,604 Plug-in Prong has wire arrangement
(#TTT) U.S. patent application Ser. No. 13/870,253 desk top items has wire arrangement.

This application also is Continue filing basing on co-pending of co-pending filing for
(#KKK-5) U.S. patent application Ser. No. (not know yet) Filed on Jun. 18, 2015
   which is Continuation filing of the application is a continuation of
(#KKK-3) U.S. patent application Ser. No. 14/728,369
   which is Continuation filing of the application is a continuation of
(#KKK-2) U.S. patent application Ser. No. 14/265,838
   which is Continuation filing of the application is a continuation of
(#KKK-1) U.S. patent application Ser. No. 14/265,738

### BACKGROUND OF THE INVENTION

This application has subject matter in common with the inventor's prior U.S. patent application Ser. Nos. 12/624,621 (#II-09), 12/318,471 (#GG-08), 12/318,470 (#FF-08), 12/318,473 (#EE-08), 12/292,153 (#DD), 12/232,505 (#CC), 12/232,035 (#BB), 12/149,963 (#AA), 12/149,964 (#Z), 12/073,095 (#Y-08), 12/073,889 (#X), 12/007,076 (#W), 12/003,691 (#V), 12/003,809 (#F), 11/806,285 (#R-07), 11/806,284 (#H-05), 11/527,629 (#L-06), 11/498,874 (x), 12/545,992 (#J-3), 12/806,711 (#S-07), 12/806,285 (#R-07), 12/806,284 (x), 12/566,322 (#M-1), 12/527,628 (M-06), 12/527,629 (#L-06), 12/527,631 (#J-06), 12/502,661 (#J-1), 11/498,881 (#I-06), 11/255,981 (#H-05), 11/184,771 (#G-05), 11/152,063 (#F-05), 11/094,215 (#E-05), 11/092,742 (#D-05), 11/092,741 (#C-05), 11/094,156 (#B-05). 11/094,155 (#A-05). 10/954,189 (#5), 10/902,123 (#4), 10/883,719 (#3), 10/883,747 (#2), 10/341,519 (#1), 12/545,992 (#J-3), 12/292,580 (#J-2), 12/710,918 (#NN-10), 12/622,000 (#HH-09), 12/710,561 (#JJ-10), 12/711,456 (#OO), 12/771,003 (#QQ-10).

The above-listed prior applications of the inventor apply optics theory to LED lights for outdoor or indoor applications and powered by alternating current (AC) or direct current (DC) supplied by and electric cord and plug for an outlet, or by a battery, transformer, solar cell, or other power source to create a plurality of LED light beams to illuminate both close areas and remote areas, the latter by projection means. Other features disclosed in the listed prior patent applications of the inventor and which may be incorporated with present invention in any combination, include the use in an LED light of more than one light source, more than one function, more than one optics means, more than one projection means, and super power saving circuits and cost saving concepts.

The market-available LED light has only one surface on which to install the LED elements that offer the light function, as well as other circuitry and components of the LED light. The current invention is an LED light with multiple surfaces, at least one of the multiple surface(s) being installed with at least one LED element that provides at least one pre-determined function, light output, color, effects, and light performance of the type that may also be provided by conventional market-available LED light devices, the other surfaces being installed with other electric devices, circuits, or components, which may be selected from receiving-units for any kind of electric device, such as 1.outlets, 2.sockets, 3.adaptors, 4.hubs, 5.USB sockets, 6.memory storage sockets, 7.memory stick sockets, 8.memory card sockets, 9.Internet sockets, 10.interface card sockets, 11.prong sockets, 12.quick connector sockets, 13.male or female connector ends, and 14.any electric device's connector, 15.power connector, 16.electric signal connector, 17.cable connector, 18.other light source, 19.second light device, 20.sound device, 21.sensor device, 22.alarm device, 23.time related device or 24.any other electric or mechanical device.

The multiple surface LED light of the current invention not only offers illumination but also offers other electric or mechanical device functions on the other surface(s) to save people money and save space by providing multiple functions for certain locations.

The multiple surface light of the current invention has a frame with an opening to enable the multiple surface LED light to change surfaces by an external force applied to the LED light. The frame and opening, depending on the number of surfaces needed, can be any design. For example, for 2 surfaces, the LED light can have a round opening and frame that allows two extended bars of the LED light to be rotated from the first surface to other surface. The LED light also can have more than two surfaces, such as three surfaces, four surfaces, five surfaces, six surfaces or N (any number of) surfaces, the opening and frame being easily designed to accommodate the number of surfaces needed.

The multiple surface LED light of the current invention may consist of desired parts and accessories selected from a P1.frame, P2.opening, P3.locking means, P4.extend bars, P5.holding means, P6.support means, P7.fixing means, P8.elastic means, P9.screw means, P10.clip tight means to enable the LED light to be installed on any surface by itself or in a group of LED lights, the surfaces including a main substrate of a S1.desk, S2.wall, S3.ceiling, S4.bar, S5.tube, S6.fence, S7.closet, S8.cabinet, S9. power strip, S10.ight fixture, S11.light bar, S12.door, S13.window, and S14.rack for indoor or outdoor application, with optional waterproofing or protection from the environment.

The LEDs included on the first surface of the multiple surface LED light of the current invention may include any LED type, LED color, LED brightness, LED output, number of LEDs, shape of LED, LED dimensions, raised LEDs, flat type LEDs, SMT LEDs, recessed LEDs, and any corresponding shades, covers, lenses, or decorative parts that may be added to increase the value of the LED light. For example, when the LED light device of the current invention is arranged for desk top use, one can put any kind of home-available water bottle, milk bottle, glass, cup, balloon, light transmitting material, transparent material, or translucent material on top of the said LED elements on the first surface to provide different light effects. one does not even need a shade, cover, or lens for the LED elements because the current invention allows people to play with any kind from home-available items to change light effects.

The multiple surface LED light of the current invention can have its own frame arranged to fit on any surface by itself, including floor, ground, walls, ceilings, boards, cabinets, closets, and doors for indoor or outdoor use, or on any surface of a main object such as a light fixture, light set, light device, power strip, or other objects that form a finish product.

The external force that causes the multiple surface LED light device of the current invention to change to another surface may come from people, or machine or mechanical device.

The multiple surface LED light of the current invention may incorporate an electric parts and accessories for other function(s) selected from any combination of E1.resistor, E2.capacitor, E3.IC chip, E4.transistor, E5.diode, E6.sensor means, E7.switch means, E8.timer means, E9.time delay means, E10.adjustable means, E11.sensitivity means, E12.variable electric value means such as camera device, E13.wireless control means, E14.transmitter and receiver means (Wireless communication device), E15.PIR means (motion sensor system), E16.infrared means, E17.Bluetooth means, E18.photo sensors, E19.manual switches, E20.automatic means to make the said LED element(s) and other function(s) achieve pre-determined functions, effects( ), and performance(s).

The electric signal connection used by the LED light device of the current invention may incorporate conventional signal connections or apply the signal connections taught in the inventor's prior U.S. Pat. No. 7,824,185 (#BB-08) U.S. Ser. No. 12/232,035 Sep. 10, 2008 filed Public number 2009-001-1627 Public date Jan. 8, 2009 or the inventor's copending US 2008/0266 856 (#SS-07) U.S. Ser. No. 12/073,889, Mar. 11, 2008 filed, Oct. 30, 2008 public now U.S. Pat. No. 7,618,150.

### BRIEF DESCRIPTION OF THE DRAWINGS

FIG. 1 shows a first preferred embodiment of a multiple surface LED light with surfaces 1A, 1B, 1C, and 1D installed in a recess and having a first surface that includes at least one LED elements. When an external force is applied to the LED light, the first surface will rotate to expose a second surface that may be fixed in position by lock means and that offers people outlets for a power source, Internet socket, and phone socket to conveniently provide multiple functions in one location on the said LED light and thereby save a lot of space, especially for a working table or under cabinet light fixture.

FIGS. 2A, 2B, 3A, and 3B illustrate one application for the first preferred embodiment in which the multiple surface LED light been applied to a floor, ground, ceiling, walls, door, or other surface by itself without any other main objects, substrates, or housing means, i.e., in which the multiple surface LED light is directly installed in or built-into a building, house, large furniture, or other permanent fixture such as floor, ground, ceiling, wall, door, closet, or cabinet, rather than having a separate housing as is the case with power strips, LED light fixtures, light devices, and light bars.

FIG. 2AA and FIG. 2BB illustrate the other application of the multiple functions LED light device which also has the multiple surface construction on the surface FIG. 2AA has the (1) LED as USB Charger indicator light not for illumination purpose (2) optional other LED(s) arrangement for illumination (3) USB port for charging or hubs or both purpose and number from 1 to N (Any number) (4) Outlets number from 1 to N (Any number) on the 1^{st} surface.

FIG. 2BB show the preferred 2′ surface which has Any number of the

(A) Outlet(s) to supply the AC current for any number as requirement and
(B) USB port(s) to offer the Direct current to charge the other electric device or act as hub to distribute the data to variety of the device such as memory card, printer, light, fan, coffee heater or other DC appliance or device. The USB also can be any type of the construction including type c which can supply power, deliver data and other multiple functions and
(C) Sensor to detect the light, motion, movement, heat and
(D) Camera or IP-Cam or Driving-Cam which can shoot the photos or video and/or record sound for desired quality and
(E) Memory kit or memory storage device to storage the photos, video, sound or any digital data which can display or replay or show at the other electric device such as mobile phone, computer, communication device. Other electric devices can show photos, video or sound.
(F) Digital data deliver means by wired or wireless communication assembly with antenna to send the digital data by email, line, what's App, face book, skype, or other internet, wifi, lourder, z-ways to the receiver end(s) so can know the status of the camera and sensor locations.
(G) Night vision device to help the camera to take photos or video at the dark environments so can see clear image to recognize the people and face and details movement.
(H) Recorder or Speaker or Micor phone related sound device to let people to listen, record, talk, play, replay the sound related data and also can make multiple ways talking for plurality of parties.

The said Multiple functions LED light device can rotate or move housing to change (1) Surface from 2st surface to other surface or (2) Change each surface relative position, location, orientation and each surface has desired LED light(s), outlets(s), USB portgs for charging and or hubs, sensor(s), camera(s) storage memory unit, wireless communication device, antenna, speaker, microphone, recorder to get desired charging, power, electric or digital data transmit or wireless multiple ways communication to electric receiving device(s) such as mobile phone, computer, display device, wifi, what's app, line, emails or skype or internet connection to get digital data or image, massage, sound, talking or monitor the status of the camera locations and take action accordingly.

From FIG. 4AA and FIG. 5AA and FIG. 6AA and FIG. 6BB show the other multiple Function LED light which also has multiple discrete and separate housing device has more than one of the surface construction to become one multiple surface LED light which has multiple functions.

From FIG. 4AA show multiple functions LED light has plurality of surface which can change each surface related position, location, orientation so can make in more than one axis for transform shape to get electric device(s) on each surface has desire space with other surface's electric device. This offer people can adjust the space while use a big transformer, Night light, Air Freshener, Clock, or USB Charger has cradle for sitting the iphone or ipad on the said USB charger device. This also fall within the current invention features to make multiple surface can be changeable features.

From FIG. 4AA show the surface has (aa) LED (bb) Outlets (cc) USB port for Charging or Hub purpose (dd) sensor (ee) camera with microphone or speaker (ff) memory storage kits (gg) antenna (hh) night vision device as above discussed.

The said FIG. 4AA the multiple functions LED light has 3 discrete and separate housing unit connected and each surface can movable along the center unit to make 180 degree angle adjustable. FIG. 5AA show the side view with the wall plug-in prongs which can be 2 prong or 3 prongs has grounded prong. The 2 prongs unit for heavy loaded can add No. 3 grounded pole which is plastic pole to help to tightly while had heavy loaded such as iphone or ipad sit on the USB ports areas or has big transformer insert into the outlets(s). The 180 degree adjustable angle can enlarge the space between the USB or outlets spacing so can avoid the too close or too narrow space while insert the bigger transformer or iphone or ipad for USB Charger.

From FIG. 4AA transform to FIG. 6 AA show the features for current invention for Multiple surface LED light which can have the each surface change to other construction. Same as FIG. 4AA to FIG. 6BB show the different arrangement for each surface of FIG. 4AA and FIG. 6BB, the electric device(s) on each surface can combine any assortments as market requirement. From FIG. 6AA and FIG. 6BB show the 2 arms surface(s) is fold together and not spread out from 6 o'clock position to 12 o'clock position that means from 0 degree to 180 degree. At 0 degree it will not good for the bigger transformer to plug-in the outlets. If one outlet had big transformer, that may block out the other outlets and USB port, so move the 2 arms separate to certain angle such as 60 degree from 0 degree, then, it will make the all 3 outlets and 3 USB ports can connect with other electric device(s).

The FIG. 4AA, FIG. 6AA, FIG. 6BB also has built-in sensor kits+Camera+memory storage device+Wired or wireless communication assembly including good antenna to transmit or deliver or use wireless internet, network, APP software to send the digital data took by camera and storage inside storage device to the receiver's device though internet, net work, SIM card, Wifi, 3G/4G/5G or update higher networks by sending email, call, message, line, what's APP, facebook to receiver end including mobile phone, computer, communication device, consumer device, receiver device.

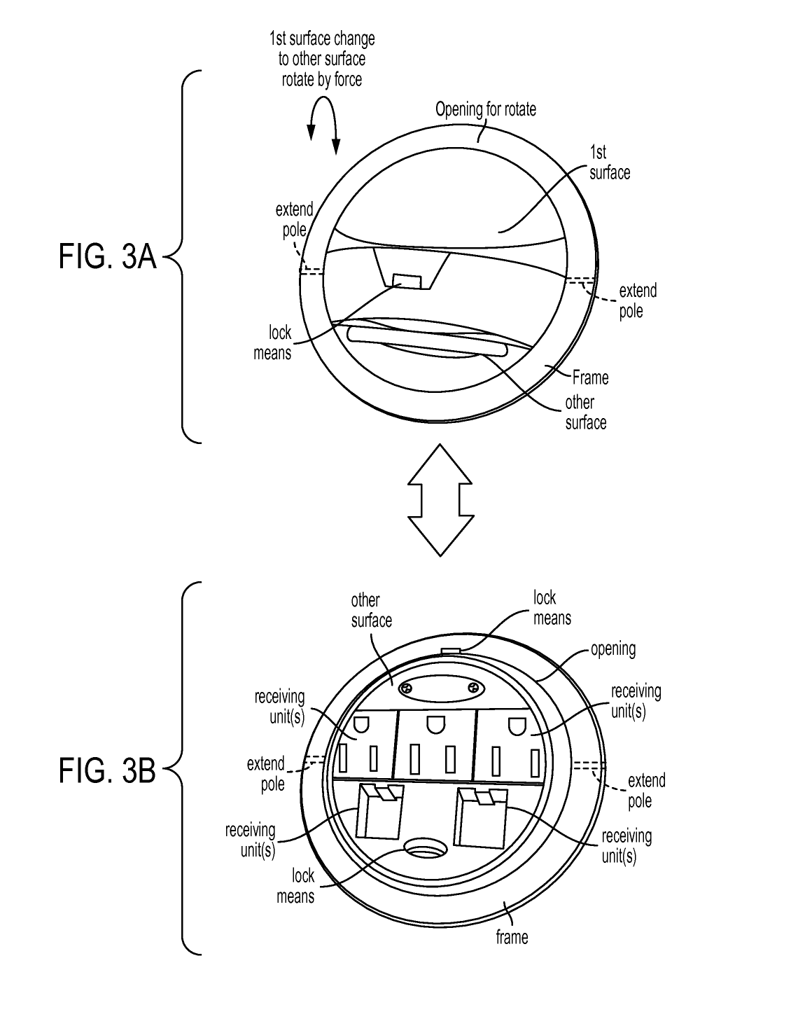

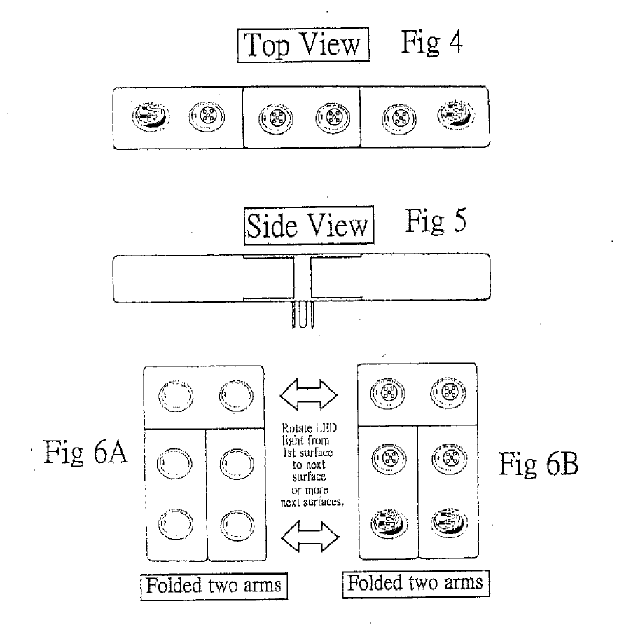

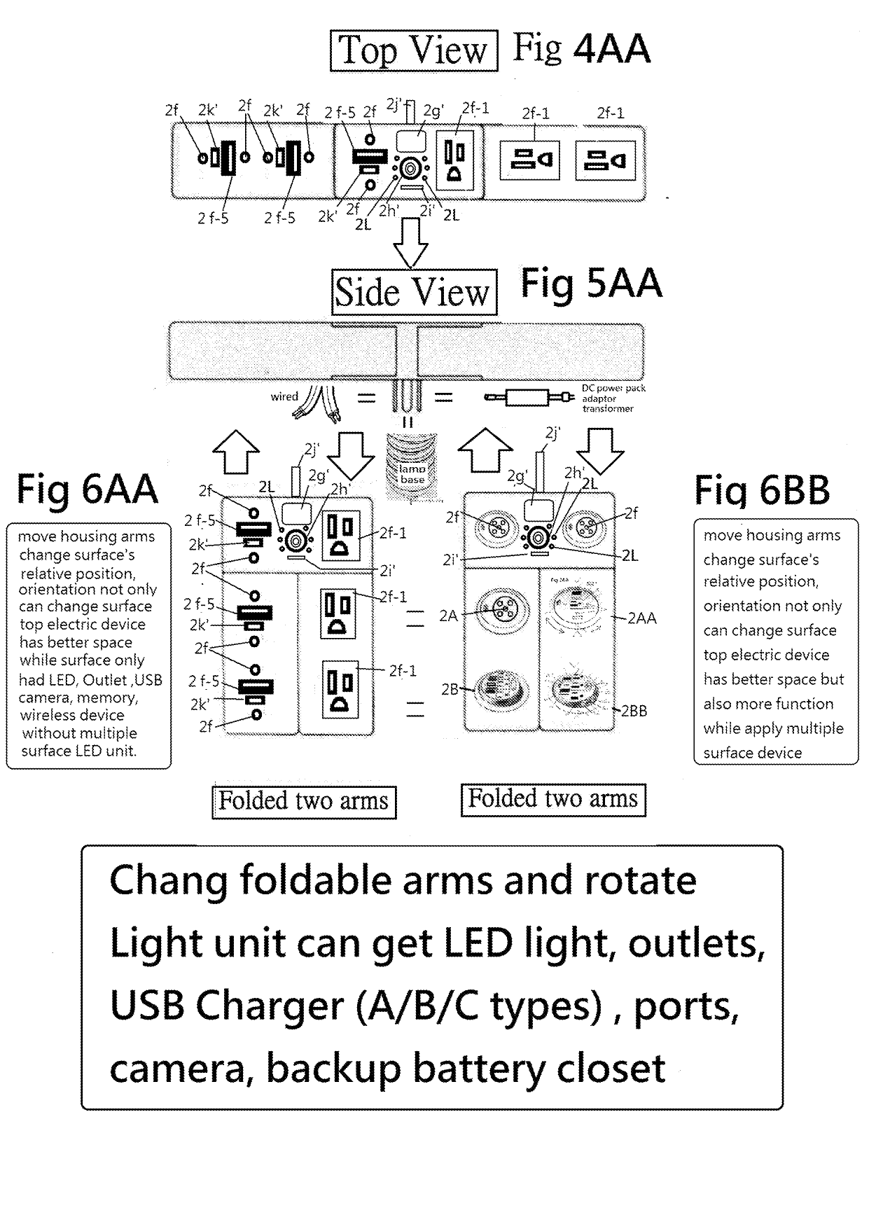

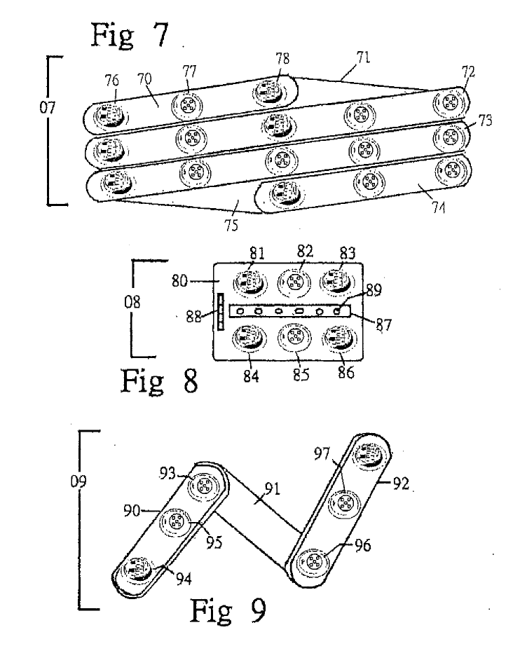

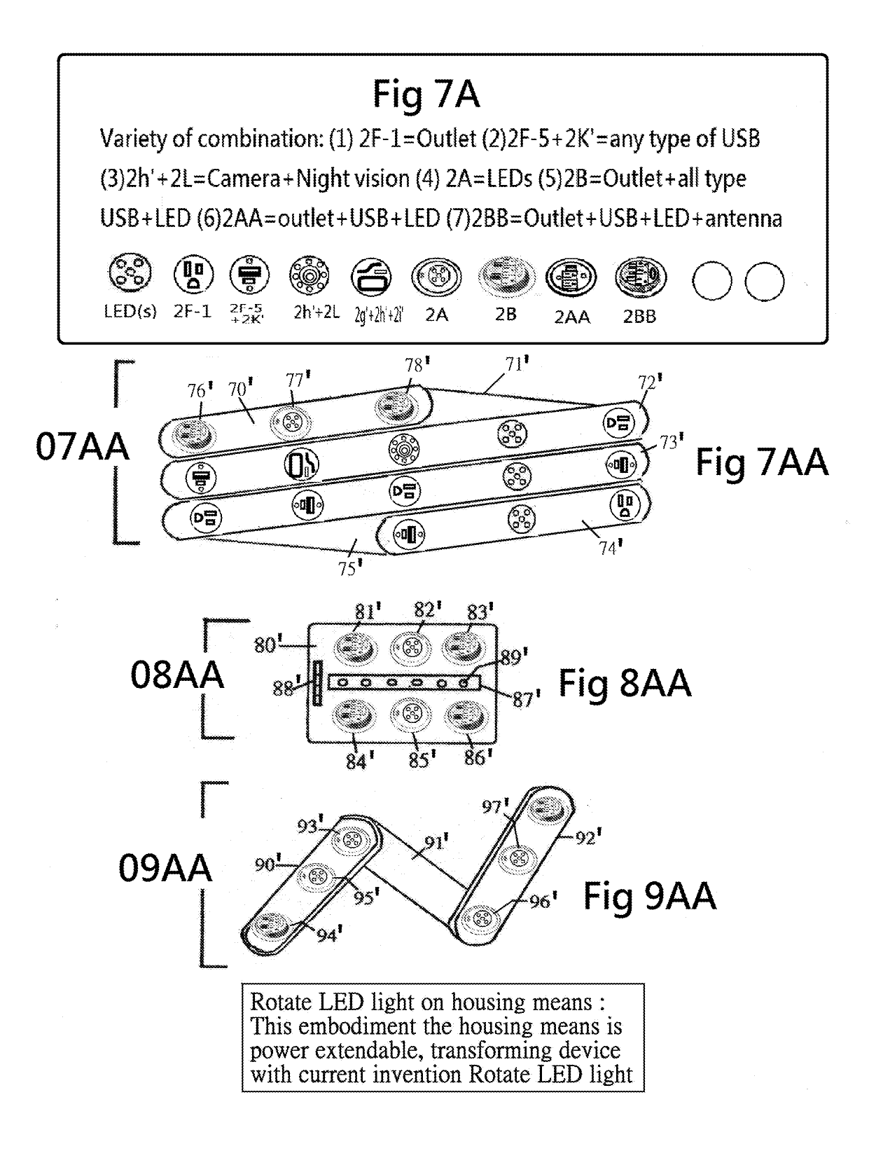

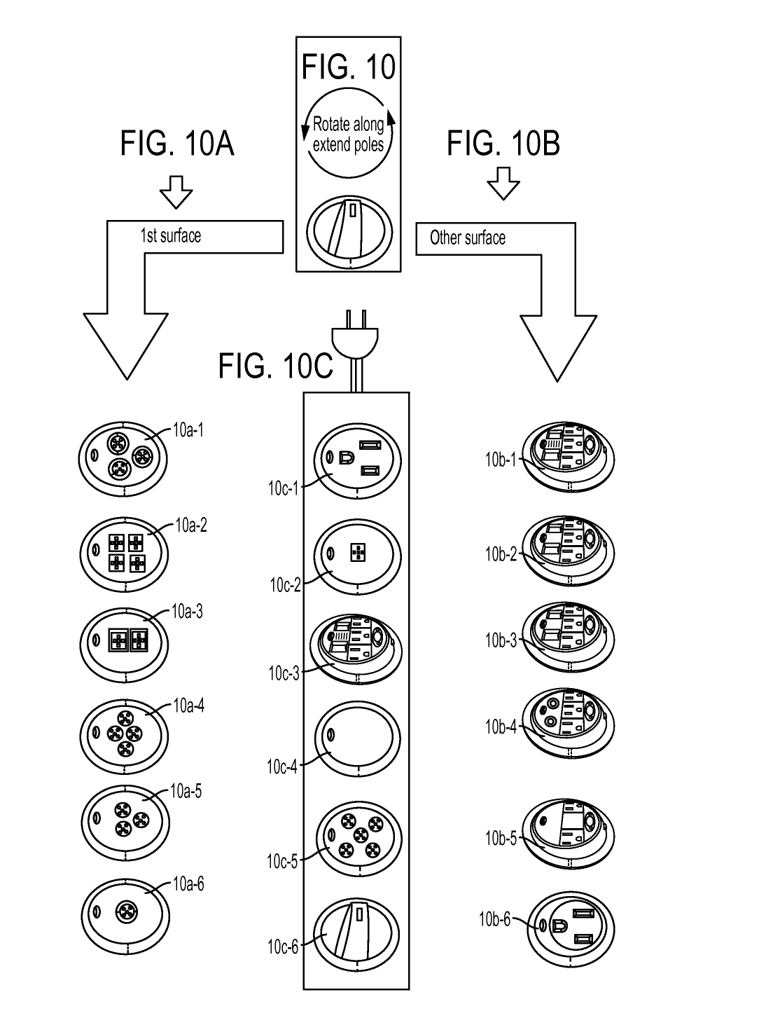

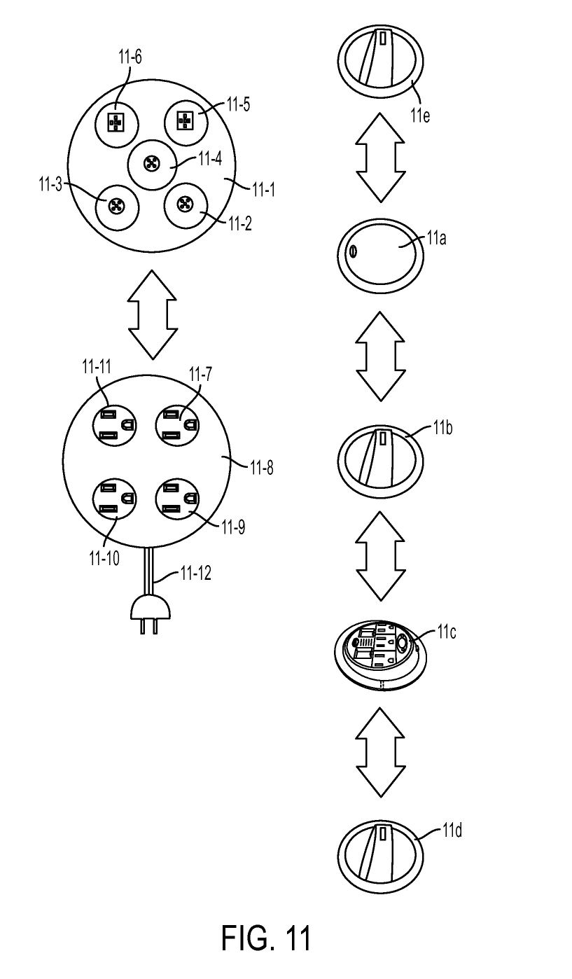

From FIG. 4AA and FIG. 6AA can see the electric device on the surface is (aaa) LED (bbb) Outlets (ccc) USB ports for charging or hub for all type of USB including C-type or D-type or any other update USB type. The FIG. 4AA also similar with co-inventor prior arts Including U.S. Ser. No. ______, The current FIG. 4AA has upgrade assorted has add functions including (ddd) Sensor (eee) Camera & sound device (fff) memory storage device (ggg) wired or wireless communication assembly with antenna (hhh) night vision device to take good video at the dark environment. From FIG. 6BB each surface built-in more complicated electric device and everyone has more than one surface and each surface can change to other surface by rotating the housing so can show the other surface and hide the last surface as the FIG. 3A and FIG. 3B shown. This FIG. 6AA will has more thickness because has other surface with plurality of electric device on the other surface which is hide under the TOP surface of the multiple functions LED light.

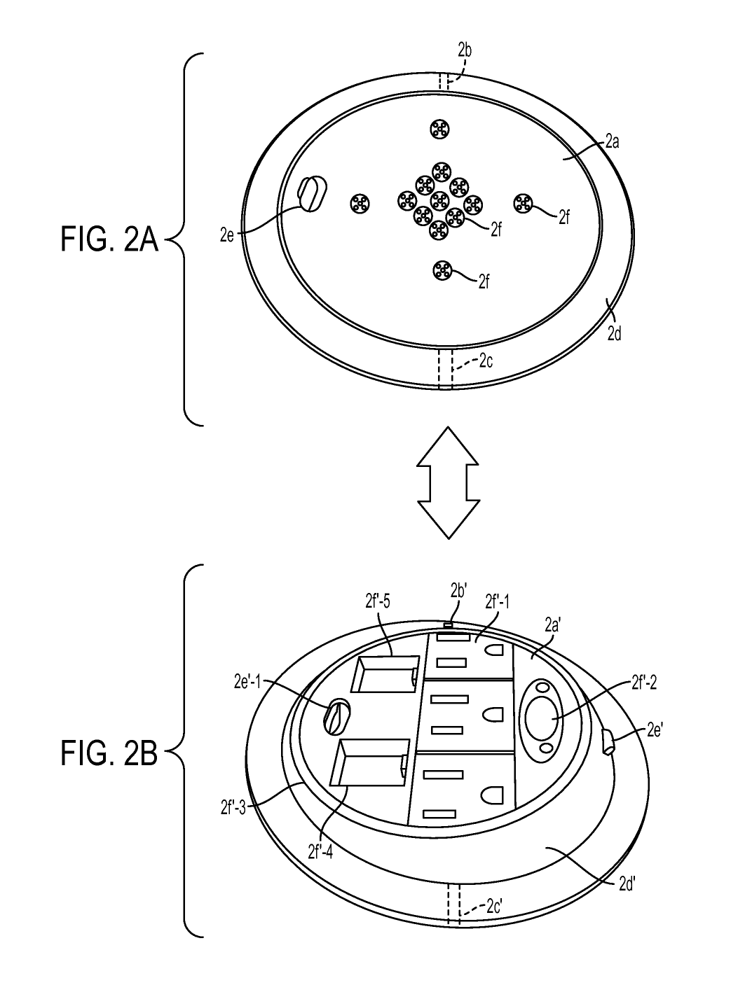

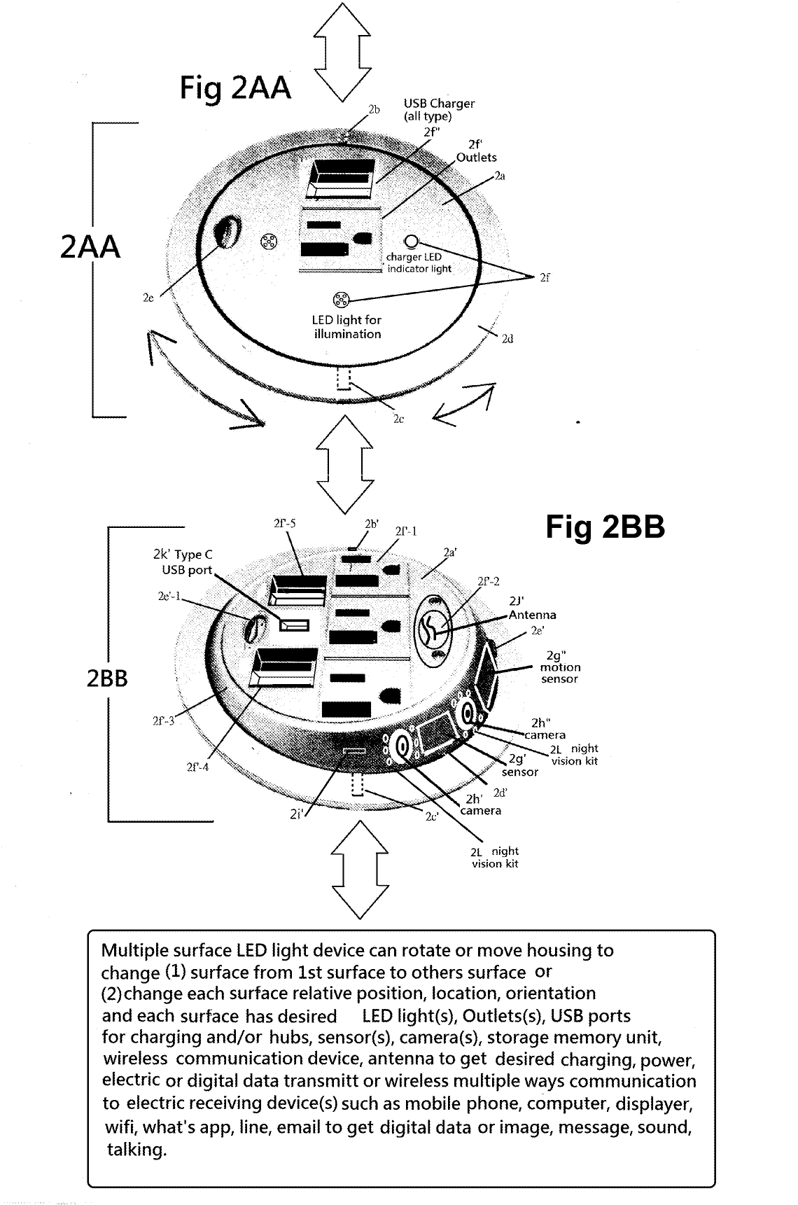

From FIG. 7A show the current inventions all kind of electric device on surface and can has desire combinations from this 9 preferred electric functions. From the drawing show
(A1) LED or LEDs: for illumination or indicator light
(A2) Outles: supply the Alternative Current to other electric devices(s).
(A3) USB port: supply the DC current to other electric device(s) or supply digital data same as USB Hub function. The USB model including type-C or upgrade Type-D . . . .
(A4) Camera with optional Night Vision kits: Take photos or video and/or audio and/or digital data for desired areas.
(A5) Wired or Wireless communication to transmit photos, video, audio, or digital data to receiver end(s) has optional antenna and memory storage device such as SD card, Micro SD card or other type of memory storage device.
(A6) Surface as FIG. 2A for electric device 2A has details discussion inside content.
(A7) Surface as FIG. 2B for electric device 2B has details discussion inside content.
(A8) Surface as FIG. 2AA for electric device 2AA has details discussion inside content . . . .
(A9) Surface as FIG. 2BB for electric device 2BB has details discussion inside content.

From FIG. 7AA show the extendable, changeable, transformable LED light as co-inventor's prior art US patent (such as the ones disclosed in the inventor's (#BB-08) U.S. Pat. No. 7,824,185), wall outlet devices, LED light devices (such as the one disclosed in the inventor's (#S-07) U.S. Pat. No. 7,618,150), foldable devices, extendable devices (such as the one described in the inventor's (#AA-08) U.S. Pat. No. 7,722,230, removable devices (such as the one described in the inventor's (#V-08) U.S. Pat. No. 7,726,839), and transforming devices (as described in the inventor's (#W-08) U.S. Pat. No. 7,726,841). The current invention modifies these existing products to become even more useful and practical items because it provides more functions as above listed (E1 to E20) and (A1 to A10) or the other electric device, circuit, components functions as above listed (1 to 24) in the same space occupied by the original products. These co-inventor's explain the all features cover the (#V (#W) (#X) (#Y) (#Z) (#BB) which disclosure the LED(s) and Outlets install on the extendable, changeable, transforming construction. Now, the current invention just add the FIG. 7A listed add (A-1) to (A-10) for each electric device same as prior arts for (LEDs) and (Outlet) so the current invention can become more functions than the co-inventor's prior arts for all these extendable, changeable, transformable construction.

From FIG. 7AA can see the device has all FIG. 7A listed (A-1) to (A-10) electric device on each surface and the construction is extendable from FIG. 7AA to FIG. 9AA so the each surface will have different position, location, orientation v.s. the FIG. 7AA which offer the extra space to allow the each electric device on each surface can install any bigger size or heavy electric and not block out the other electric device such as outlets or hubs or USB chargers or LED light beam. Further more the FIG. 7AA also can take photos/video/audio or digital data and transmit by wired or wireless network communication assembly to electric receiver such as mobile phone, computer though the market available internet, net work, software, line, Skype, what's App, Facebook, or other wireless media or channel or equipment for wireless communication for multiple-ways talking or message.

From FIG. 7AA is the most important features as co-inventor's prior art cover the (1) LED unit and (2) outlet unit. The FIG. 7AA show has added the (A-1) to (A-10) all same as LED unit and Outlets unit and can just replace the (A-1) to (A-10) but still fall within the inventor's scope and concept. Any the extendable, retractable, changeable, transformable the relative surface position, location, orientation so can change the space for each of the electric device(s) install on the said surface including (A-1) to (A-10) electric device(s) should be fall within the current invention scope and it should be Continue filing basing on co-pending

### (# UU); and

(#R) Multiple functions LED Night Light; and
(#FFF) Plug-In prong USB Charger
(# SSS) Desktop Hand reachable USB Power station; and
(#RRR) Plug-in Prong has wire arrangement
(#TTT) desk top items has wire arrangement. (such as the ones disclosed in the inventor's (#BB-08) U.S. Pat. No. 7,824,185), wall outlet devices, LED light devices (such as the one disclosed in the inventor's (#S-07) U.S. Pat. No. 7,618,150), foldable devices, extendable devices (such as the one described in the inventor's (#AA-08) U.S. Pat. No. 7,722,230, removable devices (such as the one described in the inventor's (#V-08) U.S. Pat. No. 7,726,839), and transforming devices (as described in the inventor's (#W-08) U.S. Pat. No. 7,726,841). The current invention modifies these existing products to become even more useful and practical items because it provides more functions as above listed (E1 to E20) and (A1 to A10) or the other electric device, circuit, components functions as above listed (1 to 24) in the same space occupied by the original products.

From FIG. 8AA show the same concept of extendable, retractable, changeable, transformable construction to has the electric device at least one of the (A-1) to (A-10) to install on the one of the surface of the said multiple function LED light which is powered by Plug-in Prong or Battery powered or AC powered or DC powered.

The FIG. 8AA has 6 electric device which are same as FIG. 2A and FIG. 2B for electric device (2A) (2B) on the surface or can use FIG. 2AA, FIG. 2BB shown electric device (2AA) (2BB). This embodiment will has more thicker housing so can install the other surface hidden within the housing body than the FIG. 7AA which do not has the other side electric device(s) are under the surface and within the housing body.

The FIG. 9Aa who the FIG. 2A, FIG. 2B, FIG. 2AA, FIG. 2BB electric device (2A) (2B) (2AA) (2BB) which has the one surface on top and other surface under the surface has different electric device(s) are hidden within the LED light's housing body. The FIG. 9AA show how to make the extendable, retractable, changeable, transformable construction change and make the space for each of electric device on different surface been separate and increase space after people make the extend, retract, change, transform the said Multiple functions LED light.

FIGS. 4, 5, 6A, 6B, 7, 8, 9, 10, 10A, 10B, 10C, and 11 illustrate other applications of the multiple surface LED light of the first preferred embodiment in which the multiple surface LED light been applied to other main objects, other substrates, or other housing means in the form of individual existing products available in the marketplace, such as power strips, light fixtures, extension cords (such as the ones disclosed in the inventor's (#BB-08) U.S. Pat. No. 7,824,185), wall outlet devices, LED light devices (such as the one disclosed in the inventor's (#S-07) U.S. Pat. No. 7,618,150), foldable devices, extendable devices (such as the one described in the inventor's (#AA-08) U.S. Pat. No. 7,722,230, removable devices (such as the one described in the inventor's (#V-08) U.S. Pat. No. 7,726,839), and transforming devices (as described in the inventor's (#W-08) U.S. Pat. No. 7,726,841). The current invention modifies these existing products to become even more useful and practical items because it provides more functions as above listed (E1 to E20) and (A1 to A10) or the other electric device, circuit, components functions as above listed (1 to 24) in the same space occupied by the original products.

### DETAILED DESCRIPTION OF THE PREFERRED EMBODIMENTS

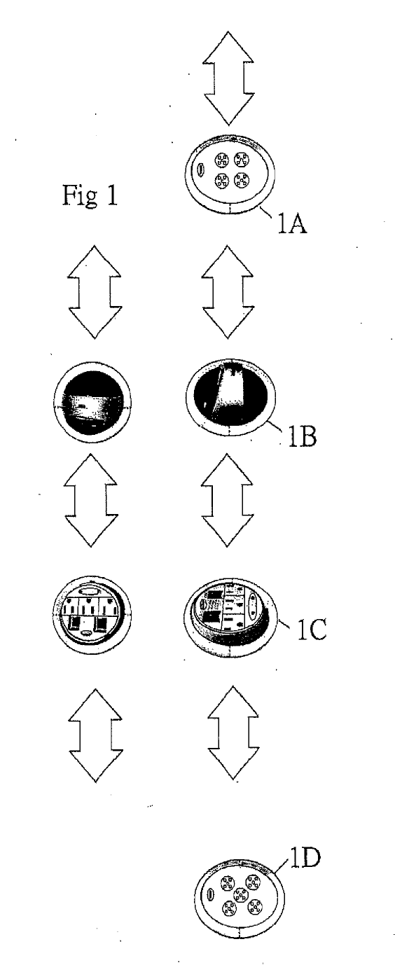

FIG. 1 a first preferred embodiment of a multiple surface LED light installed in a recess and having a first surface 1A that includes at least one LED element. When an external force is applied to the LED light to cause it to rotate, as indicated by 1B, a second surface is exposed, as shown in 1C, and fixed in position by lock means to offer people outlets for a power source, an Internet socket, and a phone socket, thereby providing people with additional convenient functions at the same location as the LED light. The multiple surface LED light may continue to rotate to return to the first surface, as indicated by 1D when an external force is again applied to the LED light so that it can be continuously rotated As indicated in the notes included in 1A-1D, the LED light may have more than two surfaces and rotate to each of the surfaces successively, with the LED light being provided with poles to enable rotation. The second surface illustrated in FIG. 1C may not only include power outlets and internet/phone connections, the second surface may include (a) USB ports, (b) digital data storage device ports, (c) memory device ports, (d) charger sockets, (e) jacks, (f) adaptors, and (g) various plug means and (h) other connectors for multiple function(s) rather than the illumination. The shape of the surface is not limited to circular, but may also include other frame shapes such as hexagonal or multiple edge shapes, and the number of surfaces may for example be six, four, or three as well as the illustrated two sides.

The single location of the multiple surfaces therefore can provide multiple electric applications, as shown in FIG. 1, which will save a lot of space, especially for a working table or under cabinet light fixture.

FIGS. 2 and 3 an application of the light device of the first preferred embodiment, in which the multiple surface LED light may be applied to a floor, ground, ceiling, walls, door, or even a surface by itself without any other main object, substrate, or housing. The phrase “by itself” means that the multiple surface LED light is directly installed in a building, house, furniture, floor, ground, ceiling, wall, door, closet, or cabinet rather than being provided as a discrete unit as is the case with conventional power strips, LED light fixtures, light devices, and light bars.

As shown in FIG. 2, the first surface (2a) has a plurality LEDs or an LED dot matrix array made up of LED sets (2f) installed on the first surface (2a), and two bars including an extended top bar (2b) and low bar (2c) that provide a pivot axis about which the LED light can be rotated. The two extended bars also have an inner channel to enable electric signal delivery from ends of the bars into the LED light. The electric connections of the embodiment of FIG. 2 may correspond to inventor's prior electric connections shown in the drawing figures on pages 8 to 13 of the present drawings, or may utilize any other conventional electric signal delivery means. The electric signal connection used by the LED light device of the current invention may incorporate conventional signal connections or apply the signal connections taught in the inventor's prior U.S. Pat. No. 7,824,185 (#BB-08) U.S. Ser. No. 12/232,035 Sep. 10, 2008 filed Public number 2009-001-1627 Public date Jan. 8, 2009 or the inventor's copending US 2008/0266 856 (#SS-07) U.S. Ser. No. 12/073,889, Mar. 11, 2008 filed, Oct. 30, 2008 public now U.S. Pat. No. 7,618,150.

A lock means (2e) enables the LED light to be locked in a particular position without changing the surface to another surface. For example, when the LED light is in the position shown in FIG. 2B, if a lock means were not provided it would be too easy to rotate the device to a different position, which could be very dangerous in the case where a prong means has been inserted into the outlet socket(s) (2f-1). The lock means (2e) (2e′) (2e′-1) not only provides a locking functions, but also may act as s release means to enable the LED light to be changed from a first surface to other surfaces as needed. The other surfaces (2a′) may has the outlet sockets (2f′-1), Internet sockets (2f′-5), phone sockets (2f′-4), and/or sensor means (2f′-2) to offer people a very convenient LED light with multiple functions when the surfaces are changed.

FIG. 3 shows additional details of the construction of the LED light of FIG. 2 of LED light and the manner in which it rotates from the first surface, shown in FIG. 3A, to another surface shown in FIG. 3B, by rotating about the extended poles upon release of the lock means shown therein. The respective surfaces shown in FIGS. 3A and 3B correspond to those shown in FIGS. 2A and 2B.

FIG. 2AA and FIG. 2BB illustrate the other application of the multiple functions LED light device which also has the multiple surface construction on the surface FIG. 2AA has the (1) LED (2f) as USB Charger (2r) indicator light not for illumination purpose (2) optional other LED(s) arrangement for illumination (3) USB port (2f′) for charging or hubs or both purpose and number from 1 to N (Any number) including the type-C USB (4) Outlets (2f′) number from 1 to N (Any number) on the 1st surface.

FIG. 2BB show the preferred 2′ surface (2a′) which has Any number of the

(A) Outlet(s) (2f′-1) to supply the AC current for any number as requirement and
(B) USB port(s) (2f′-5) (to offer the Direct current to charge the other electric device or act as hub to distribute the data to variety of the device such as memory card, printer, light, fan, coffee heater or other DC appliance or device. The USB also can be any type of the construction including type c (2k′) which can supply power, deliver data and other multiple functions and
(C) Sensor (2g′) to detect the light, motion, movement, heat and
(D) Camera (2h′) or IP-Cam (2h′) or Driving-Cam (2h′) which can shoot the photos or video and/or record sound for desired quality and
(E) Memory kit and slot (2i′) or memory storage device and slot (2i′) to storage the photos, video, sound or any digital data which can display or replay or show at the other electric device such as mobile phone, computer, communication device. Other electric devices can show photos, video or sound.
(F) Digital data deliver means by wired or wireless communication assembly (not shown) with antenna (2j′) to send the digital data by email, line, what's App, face book, skype, or other internet, wifi, lourder, z-ways to the receiver end(s) so can know the status of the camera and sensor locations.
(G) Night vision device (2L) to help the camera to take photos or video at the dark environments so can see clear image to recognize the people and face and details movement.
(H) Recorder (Not shown) or Speaker (Not shown) or Micor phone (Not shown) related sound device to let people to listen, record, talk, play, replay the sound related data and also can make multiple ways talking for plurality of parties.

The said Multiple functions LED light device can rotate same as FIG. 2A,2B,2AA, 2BB or move housing same as FIG. 4,5,6,7 4AA,5AA,6AA,7AA to change (1) Surface from 1st surface to other surface or (2) Change each surface relative position, location, orientation and each surface has desired LED light(s) (2f), outlets(s) (2f′-1), USB ports (2f′-5) for charging and or hubs, sensor(s) (2g′), camera(s) (2h′), storage memory unit (2i′), wireless communication device (not shown), antenna (2j′), speaker, microphone, recorder to get desired charging, power, electric or digital data transmit or wireless multiple ways communication to electric receiving device(s) such as mobile phone, computer, display device, wifi, what's app, line, emails or skype or internet connection to get digital data or image, massage, sound, talking or monitor the status of the camera locations and take action accordingly.

From FIG. 4AA and FIG. 5AA and FIG. 6AA and FIG. 6BB show other type multiple Function LED light which also has multiple discrete and separate 3 housing device has more than one of the surface construction to become one multiple surface LED light which has multiple functions.

From FIG. 4AA show multiple functions LED light has plurality of surface which can change each surface related position, location, orientation so can make in more than one axis for transform shape to get electric device(s) on each surface has desire space with other surface's electric device. This offer people can adjust the space while use a big transformer, Night light, Air Freshener, Clock, or USB Charger has cradle for sitting the iphone or ipad on the said USB charger device. This also fall within the current invention features to make multiple surface can be changeable features.

From FIG. 4AA show the surface has (aa) LED (2f) (bb) Outlets (2f-1) (cc) USB port (2f-5) for Charging or Hub purpose (dd) sensor (2g′) (ee) camera (2h′) with microphone or speaker (ff) memory storage kits (2i′) (gg) antenna (2j′) (hh) night vision device (2L) as above discussed.

The said FIG. 4AA the multiple functions LED light has 3 discrete and separate housing unit connected and each surface can movable along the center unit to make 180 degree angle adjustable.

FIG. 5AA show the side view with the wall plug-in prongs which can be 2 prong or 3 prongs has grounded prong. The 2 prongs unit for heavy loaded can add No. 3 grounded pole which is plastic pole to help to tightly while had heavy loaded such as iphone or ipad sit on the USB ports areas or has big transformer insert into the outlets(s). The 180 degree adjustable angle can enlarge the space between the USB or outlets spacing so can avoid the too close or too narrow space while insert the bigger transformer or iphone or ipad for USB Charger. The FIG. 5AA to get the AC power not only can have the Prong means to plug-in outlets, it also can has the screw base or other base so can connect with all kind of lamp base such as bulb lamp base, lamp socket, lamp holder or the lamp-hold-Adaptors show on the co-inventor's (# KKK=U.S. Pat. No. 8,760,514 patent) (# KKK-1=U.S. patent application Ser. No. 14/265,738) (#KKK-2=Co-pending U.S. patent application Ser. No. 14/265,838) (# KKK-3=Co-Pending U.S. patent application. Ser. No. 14/728,369) and same family patented or co-pending (# JJJ=U.S. Pat. No. 8,562,158) (#JJJ-1=U.S. Pat. No. 9,010,986) (# III=U.S. Pat. No. 8,711,216 patent), The said Lamp holder has 2 ends, One end to insert and connect with original power source and 2^{nd} end to receiving the Multiple Function LED light (Current invention items).

The FIG. 5AA the prong also can be (B-1) wired (B-2) Wire & Plug (B-3) Batteries (B-4) AC to DC adaptor (B-5) AD to DC transformer (B-6) Solar power (B-7) DC current generator (B-8) Other DC power supplier device so can use for the outdoor or location has no AC power source.

From FIG. 4AA transform to FIG. 6 AA show the features for current invention for Multiple surface LED light which can have the each surface change to other construction. Same as FIG. 4AA to FIG. 6BB show the different arrangement for each surface of FIG. 4AA and FIG. 6BB, the electric device(s) on each surface can combine any assortments as market requirement. From FIG. 6AA and FIG. 6BB show the 2 arms surface(s) is fold together and not spread out from 6 o'clock position to 12 o'clock position that means from 0 degree to 180 degree. At 0 degree it will not good for the bigger transformer to plug-in the outlets. If one outlet had big transformer, that may block out the other outlets and USB port, so move the 2 arms separate to certain angle such as 60 degree from 0 degree, then, it will make the all 3 outlets and 3 USB ports can connect with other electric device(s).

The FIG. 4AA, FIG. 6AA, FIG. 6BB also has built-in sensor kits (2g′)+Camera (2h′)+memory storage device (2i′)+Wired or wireless communication assembly including good antenna (2j′) to transmit or deliver or use wireless internet, network, APP software to send the digital data took by camera and storage inside storage device to the receiver's device though internet, network, SIM card, Wifi, 3G/4G/5G or update higher networks by sending email, call, message, line, what's APP, face book to receiver end including mobile phone, computer, communication device, consumer device, receiver device.

From FIG. 4AA and FIG. 6AA can see the electric device on the surface is (aaa) LED (2f) (bbb) Outlets (2f-1) (ccc) USB ports (2f-5) for charging or hub for all type of USB including C-type (2K′) or D-type or any other update USB type. The FIG. 4AA also similar with co-inventor prior arts the extendable, changeable, transformable LED light as co-inventor's prior art US patent (such as the ones disclosed in the inventor's (#BB-08) U.S. Pat. No. 7,824,185), wall outlet devices, LED light devices (such as the one disclosed in the inventor's (#S-07) U.S. Pat. No. 7,618,150), foldable devices, extendable devices (such as the one described in the inventor's (#AA-08) U.S. Pat. No. 7,722,230, removable devices (such as the one described in the inventor's (#V-08) U.S. Pat. No. 7,726,839), and transforming devices (as described in the inventor's (#W-08) U.S. Pat. No. 7,726,841). The current invention modifies these existing products to become even more useful and practical items because it provides more functions as above listed (E1 to E20) and (A1 to A10) or the other electric device, circuit, components functions as above listed (1 to 24) in the same space occupied by the original products. These co-inventor's explain the all features cover the (#V (#W) (#X) (#Y) (#Z) (#BB) which disclosure the LED(s) and Outlets install on the extendable, changeable, transforming construction. Now, the current invention just add the FIG. 7A listed add (A-1) to (A-10) for each electric device same as prior arts for (LEDs) and (Outlet) so the current invention can become more functions than the co-inventor's prior arts for all these extendable, changeable, transformable construction.

The current FIG. 4AA has upgrade assorted has add functions including (ddd) Sensor (2g′) (eee) Camera (2h′) & sound device (fff) memory storage device (2i′) (ggg) wired or wireless communication assembly with antenna (2j′) (hhh) night vision device (2L) to take good video at the dark environment.

From FIG. 6BB each surface built-in more complicated electric device and everyone has more than one surface and each surface can change to other surface by rotating the housing so can show the other surface and hide the last surface as the FIG. 3A and FIG. 3B shown. This FIG. 6AA will has more thickness because has other surface with plurality of electric device on the other surface which is hide under the TOP surface of the multiple functions LED light.

From FIG. 7A show the current inventions all kind of electric device on surface and can has desire combinations from this 9 preferred electric functions. From the drawing show
(A1) LED or LEDs (2f): for illumination or indicator light
(A2) Outles (2f-1): supply the Alternative Current to other electric devices(s).
(A3) USB port (2f-5): supply the DC current to other electric device(s) or supply digital data same as USB Hub function. The USB model including type-C (2k′) or upgrade Type-D . . . .
(A4) Camera (2h′) with optional Night Vision kits (2L): Take photos or video and/or audio and/or digital data for desired areas.
(A5) Wired or Wireless communication with antenna (2j′) to transmit photos, video, audio, or digital data to receiver end(s) has optional antenna (2j′) and memory storage device (2i′) such as SD card, Micro SD card or other type of memory storage device.
(A6) Surface as FIG. 2A for electric device (2A) has details discussion inside content.
(A7) Surface as FIG. 2B for electric device (2B) has details discussion inside content.
(A8) Surface as FIG. 2AA for electric device (2AA) has details discussion inside content . . . .
(A9) Surface as FIG. 2BB for electric device (2BB) has details discussion inside content.

From FIG. 7AA show the extendable, changeable, transformable LED light as co-inventor's prior art US patent (such as the ones disclosed in the inventor's (#BB-08) U.S. Pat. No. 7,824,185), wall outlet devices, LED light devices (such as the one disclosed in the inventor's (#S-07) U.S. Pat. No. 7,618,150), foldable devices, extendable devices (such as the one described in the inventor's (#AA-08) U.S. Pat. No. 7,722,230, removable devices (such as the one described in the inventor's (#V-08) U.S. Pat. No. 7,726,839), and transforming devices (as described in the inventor's (#W-08) U.S. Pat. No. 7,726,841). The current invention modifies these existing products from LED-unit and Outlet-unit to become even more useful and practical items because it provides more functions as above listed (E1 to E20) and (A1 to A10) or the other electric device, circuit, components functions as above listed (1 to 24) in the same space occupied by the original products. These co-inventor's explain the all features cover the above listed (#UU) (#V) (#W) (#X) (#Y) (#Z) (#BB) which disclosure the LED(s) and Outlets install on the extendable, changeable, transforming construction. Now, the current invention just add the FIG. 7A listed add (A-1) to (A-10) for each electric device same as prior arts for (LEDs) and (Outlet) so the current invention can become more functions than the co-inventor's prior arts for all these extendable, changeable, transformable construction.

From FIG. 7AA can see the device has all FIG. 7A listed (A-1) to (A-10) electric device on each surface and the construction is extendable from FIG. 7AA to FIG. 9AA so the each surface will have different position, location, orientation v.s. the FIG. 7AA which offer the extra space to allow the each electric device on each surface can install any bigger size or heavy electric and not block out the other electric device such as outlets or hubs or USB chargers or LED light beam. Further more the FIG. 7AA also can take photos/video/audio or digital data and transmit by wired or wireless network communication assembly to electric receiver such as mobile phone, computer though the market available internet, net work, software, line, Skype, what's App, Facebook, or other wireless media or channel or equipment for wireless communication for multiple-ways talking or message.

From FIG. 7AA is the most important features as co-inventor's prior art cover the (1) LED unit and (2) outlet unit. The FIG. 7AA show has added the (A-1) to (A-10) all same as LED unit and Outlets unit and can just replace the (A-1) to (A-10) but still fall within the inventor's scope and concept. Any the extendable, retractable, changeable, transformable the relative surface position, location, orientation so can change the space for each of the electric device(s) install on the said surface including (A-1) to (A-10) electric device(s) should be fall within the current invention scope and it should be Continue filing basing on co-pending

(# UU) Ser. No. 12/938,628; and
(#R) Ser. No. 11/806,285 Multiple functions LED Night Light; and
(#FFF) Ser. No. 13/117,227 Plug-In prong USB Charger
(# SSS) Ser. No. 13/863,073 Desktop Hand reachable USB Power station; and
(#RRR) Ser. No. 13/858,604 Plug-in Prong has wire arrangement
(#TTT) Ser. No. 13/870,253 desk top items has wire arrangement. (such as the ones disclosed in the inventor's (#BB-08) U.S. Pat. No. 7,824,185), wall outlet devices, LED light devices (such as the one disclosed in the inventor's (#S-07) U.S. Pat. No. 7,618,150), foldable devices, extendable devices (such as the one described in the inventor's (#AA-08) U.S. Pat. No. 7,722,230, removable devices (such as the one described in the inventor's (#V-08) U.S. Pat. No. 7,726,839), and transforming devices (as described in the inventor's (#W-08) U.S. Pat. No. 7,726,841). The current invention modifies these existing products to become even more useful and practical items because it provides more functions as above listed (E1 to E20) and (A1 to A10) or the other electric device, circuit, components functions as above listed (1 to 24) in the same space occupied by the original products.

From FIG. 8AA show the same concept of extendable, retractable, changeable, transformable construction to has the electric device at least one of the (A-1) to (A-10) to install on the one of the surface of the said multiple function LED light which is powered by Plug-in Prong or Battery powered or AC powered or DC powered.

The FIG. 8AA has 6 electric device which are same as FIG. 2A and FIG. 2B for electric device (2A) (2B) on the surface or can use FIG. 2AA, FIG. 2BB shown electric device (2AA) (2BB). This embodiment will has more thicker housing so can install the other surface hidden within the housing body than the FIG. 7AA which do not has the other side electric device(s) are under the surface and within the housing body.

The FIG. 9Aa who the FIG. 2A, FIG. 2B, FIG. 2AA, FIG. 2BB electric device (2A) (2B) (2AA) (2BB) which has the one surface on top and other surface under the surface has different electric device(s) are hidden within the LED light's housing body. The FIG. 9AA show how to make the extendable, retractable, changeable, transformable construction change and make the space for each of electric device on different surface been separate and increase space after people make the extend, retract, change, transform the said Multiple functions LED light.

FIGS. 4, 5, 6A, 6B, 7, 8, and 9 show the manner in which preferred multiple surface LED lights are applied directly to a floor, ground, ceiling, walls, or the surface of a building or house, and also to existing electric products. Any of the existing products that do not include the light device of the present invention will become out-of-date. More specifically, FIGS. 4, 5, 6A, 6B, 7, 8, 9 all show LED light bars, or outlet devices, extension cords, or power strips which have been modified to include the multiple surface light devices of the present invention and to be foldable as disclosed in the inventor's U.S. Pat. Nos. 7,824,185 (#BB-08) and 7,726,841 (#W-08). The present invention differs from the arrangements disclosed in the inventor's prior patents in that the foldable light fixtures disclosed therein are limited to to inclusion of outlet units or LED units, whereas the modified foldable light fixtures include light devices that can be changed to outlet devices on the different multiple surfaces so as to not only offer LED lighting but also outlets and other device with Internet, phone, motion sensor or other functions such as above listed (E1 to E20) and functions of (1 to 24).

It will be appreciated that the existing electric products to which multiple surface LED lights of the current invention's multiple surface LED light may be applied may be varied without departing from the scope of the current invention. In addition to the foldable devices, the light device of the preferred embodiments may be applied to the power strips, light fixture, and extension cord of the inventor's (#BB-08) U.S. Pat. No. 7,824,185), the wall outlet device or LED light device of the inventor's (#S-07) U.S. Pat. No. 7,618,150, the foldable device or extendable device of the inventor's (#AA-08) U.S. Pat. No. 7,722,230, the removable device of the inventor's (#V-08) U.S. Pat. No. 7,726,839, and the transforming device of the inventor's (#W-08) U.S. Pat. No. 7,726,841. All these modified existing products will become very useful and practical items because of the addition of multiple functions to the original products, which should be make them more valuable for people.

Furthermore, the current invention for the FIG. 4,5,6A,6B, 7,8,9 show the one of the co-inventor's prior arts as above listed (#BB-08) (#S-07) (#AA-08) (# V-08) (#W-08) which has the extendable, transforming, retractable power strip or power device which has the outlets and LED-unit. The current invention to upgrade for multiple functions power strip or power device has built-in all kind of receiving ports and multiple functions (E1 to E20) and (1 to 24) as above listed so upgrade power strip or power cord has built-in LED illumination, Outlets and/or USB charger for supply power, USB charger port, Wireless transmitter and receiver device, sound device, video device, memory storage device so can have multiple functions into multiple surface LED light. The said Multiple surface light is not only for on vertical axis, it should be cover for X-axis or Y-axis or Z-axis such as FIG. 1,2A,2B,2C,2D show the multiple surface in only x-axis for changing surface. FIG. 4,5,6A,6B,7,8,9,10 for the horizon Y-axis for multiple surface and all surface is changeable too for position, location, orientation. So, the multiple surface LED light unit scope should be multiple surface in x or y or z axis or any combination.

FIG. 10 shows other existing electric products to which the multiple surface light device of the present invention may be applied by adding multiple surface light devices to existing extension cords or power strips. Although the power strips have certain required specifications, it is possible to add an LED light to the outlet unit with only a limited change in dimensions because one can use an LED chip having a thickness of a few millimeters so that the multiple surface LED light with an outlet on another surface will have dimensions that are essentially the same as those of the outlet-units in the existing power strip despite the big increase in functions. For example, all power strips or extension cords can add the LED elements on a first surface and still keep the original outlet-units of the power strips or extension cords to enable the power strips or extension cords to become under-cabinet LED light units that allow people to change some of the LED lights into outlet-units other electric devices.

FIGS. 10, 10A, 10B, and 10C show different possible arrangements for the first surface (FIG. 10A) and the other surface as (FIG. 10B), with FIG. 10 show a power strip or extension cord that utilizes different first and second surface arrangements of the multiple surface LED lights.

FIG. 11 shows another preferred embodiment in the form of a round power strip or extension cord which has a plurality of the multiple surface LED lights (11-2) (11-3) (11-5) (11-6) on its surface (11-1) and each of the LED lights (11-2) (11-3) (11-5) (11-6) has LED elements with a different style, thickness, shape, brightness, color, and has control means, circuit, turn-on/turn-off timing, sensor means, switch means, power output to make the predetermined illumination and other functions, and so forth. Each of these multiple surface LED lights can change each of surfaces to other position, orientation, location, and in particular from surface (11-5) to surface (11-7), from surface (11-6) to surface (11-11), from surface (11-2) to surface (11-9), and from surface (11-3) to surface (11-10). The center unit (11-4) is not a multiple surface LED light. The side drawing shows how the multiple surfaces (11-2) (11-3) (11-5) (11-6) are changed by rotating from (11a) to (11-b) to (11-c) and to (11d), so that it is clear how to carry out a change from the first surface to another surface by external force, which may be manual or provided by a motor to automatically the design, or change the design by wireless remote control, or by other external force applying mechanisms depending on market requirements.

Finally, the manner in which electrical signal delivery is provided to the rotatable first and second surfaces may utilize the teachings of the inventor's prior U.S. Patent Publication No. 2008/0266856 (#S-07) and U.S. Pat. No. 7,824,185 (MB-08), the drawings of which are incorporated herein by reference and which show how to provide electric signal delivery from one end to another end of a rotatable, twisting, or movable coupling between units. Alternatively, the preferred embodiments may utilize any other conventional market-available skill to provide electric delivery from one movable part to another.

It is to be appreciated that the above description is not intended to be limiting, and that any alternative, same-function, or equivalent method or improvements may still fall within the scope of the current invention, i.e., that any LED light which has more than one surface and can change to other surfaces may fall within the scope of the current invention.

I claim:

1. A multiple function LED light, comprising:
a first surface including at least one LED element arranged to emit light beams according to a predetermined function, output, color, effects, and performance;
at least one additional surface including at least one of the following electric device on surface and can has desire combinations from electric functions.
(A1) LED or LEDs: for illumination or indicator light
(A2) Outles: supply the Alternative Current to other electric devices(s).
(A3) USB port: supply the DC current to other electric device(s) or supply digital data same as USB Hub function. The USB model including type-C or upgrade Type-D
(A4) Camera with optional Night Vision kits: Take photos or video and/or audio and/or digital data for desired areas.
(A5) Wired or Wireless communication to transmit photos, video, audio, or digital data to receiver end(s) has optional antenna and memory storage device such as SD card, Micro SD card or other type of memory storage device.
(A6) surface as FIG. 2A for electric device 2A has details discussion inside content.
(A7) Surface as FIG. 2B for electric device 2B has details discussion inside content.
(A8) Surface as FIG. 2AA for electric device 2AA has details discussion inside content . . . .
(A9) Surface as FIG. 2BB for electric device 2BB has details discussion inside content.
The said electric device of 2A, 2B, 2AA, 2BB at least have one of outlet; socket; adaptor; hub; USB socket; memory storage socket; memory stick socket; memory card socket; internet socket; interface card socket; prong socket; quick connect socket; male or female connector socket; electrical device connector; power connector; signal connector; cable connector; additional light source; sound device; sensor device; alarm device, time related device; digital electrical device or processor; and digital data equipment; wireless transmitter and receiver device, video device, camera; memory storage device; bluetooth device; and
Arrangement for installing the LED light has in a frame, support, or housing, the frame, support, or housing being fixed or held in a surface of another object or structure selected from a desk, wall, ceiling, floor, ground, bar, tube, fence, closet, cabinet, power strip, extension cord, light fixture, light bar, door, window, rack, and electrical device for indoor or outdoor use,
whereby the LED light offers an illumination function from the first surface and additional functions from the second surface.

2. A multiple surface LED light as claimed in claim 1, wherein a number of said at least one other surface is at least two said other surfaces.

3. A multiple surface LED light as claimed in claim 1, wherein said first surface has an arrangement of multiple LED elements in predetermined combinations of LED type, color, brightness, output, number, shape, and dimensions, and additional decorative or optical elements for enhancing an appearance and value of the arrangement of multiple LED elements.

4. A multiple surface LED light as claimed in claim 1, wherein the LED light is adapted for desktop use and for a user to place home-available objects selected from a water bottle, milk bottle, glass, cup, balloon, light transmitting material, shade, cover, and lens in front of the at least one LED element to provide different light effects.

5. A multiple surface LED light as claimed in claim 1, wherein the light device has its own said frame for mounting the light device in an opening of said device or structure.

6. A multiple surface LED light as claimed in claim 1, wherein the light device is mounted in a housing of a main object selected from a light fixture, light set, light device, and power strip to form a finished product.

7. A multiple surface LED light as claimed in claim 1, wherein said LED light changes from said first surface to said at least one other surface, and from said at least one other surface to said first surface, when an external force is applied to said LED light.

8. A multiple surface LED light as claimed in claim 1, wherein the LED light incorporates electrical parts and accessories for causing said at least one LED element to turn on and off to provide predetermined said effects and performance.

9. A multiple surface LED light as claimed in claim 1, wherein the multiple surface to change each other surface relative position, locations, orientation is for x-axis, y-axis, z-axis or any combination for x-y-z axis which at least one LED on one surface and other surface has other electric device functions.

10. A multiple surface LED light as claimed in claim 1, wherein the said multiple surface and each of the surface change position, location, orientation by rotating, extend, retractable, transforming arrangement to make the said LED-unit and the other USB-charging port, or other electric function(s) relative position, location, orientation changed.

11. A multiple surface LED light as claimed in claim 1, where the said multiple surface LED light at least one of surface has built-in LED-unit on one surface with other electric functions device and others surface has preferred electric device(s) for multiple function(s).

12. A multiple surface LED light as claimed in claim 1, where the said multiple surface LED light at least has one LED-unit on the one of surface and others surface has built-in other electric devices and non-of the LED-unit or other electric device is rotatable.

13. A multiple surface LED light as claimed in claim 1, where the said multiple surface LED light has retractable, extendable, transforming construction to change each of surface relative position, location, orientation in x-y-z axis and none of the said USB-Charger port, Outlets port, LED-unit is rotatable.

14. A multiple surface LED light as claimed in claim 1, the said multiple surface has transmitter and receiver function to incorporate digital data device to take photos, video, sound and use wireless transmit to the receiver ends to deliver the digital data including image and sound.

15. A multiple surface LED light as claimed in claim 1, the said multiple surface which can change relative position, orientation, locations and has the rotatable outlet port, USB port on desired surface.

16. A multiple function LED light, comprising:
a first surface including at least one LED element arranged to emit light beams according to a predetermined function, output, color, effects, and performance;
at least one additional surface including at least one of the following electric device on surface and can has desire combinations from electric functions.
(A1) LED or LEDs: for illumination or indicator light
(A2) Outles: supply the Alternative Current to other electric devices(s).
(A3) USB port: supply the DC current to other electric device(s) or supply digital data same as USB Hub function. The USB model including type-C or upgrade Type-D
(A4) Camera with optional Night Vision kits: Take photos or video and/or audio and/or digital data for desired areas.
(A5) Wired or Wireless communication to transmit photos, video, audio, or digital data to receiver end(s) has optional antenna and memory storage device such as SD card, Micro SD card or other type of memory storage device.
(A6) surface as FIG. 2A for electric device 2A has details discussion inside content.
(A7) Surface as FIG. 2B for electric device 2B has details discussion inside content.
(A8) Surface as FIG. 2AA for electric device 2AA has details discussion inside content . . . .
(A9) Surface as FIG. 2BB for electric device 2BB has details discussion inside content.
The said electric device of 2A, 2B, 2AA, 2BB at least have one of outlet; socket; adaptor; hub; USB socket; memory storage socket; memory stick socket; memory card socket; internet socket; interface card socket; prong socket; quick connect socket; male or female connector socket; electrical device connector; power connector; signal connector; cable connector; additional light source; sound device; sensor device; alarm device, time related device; digital electrical device or processor; and digital data equipment; wireless transmitter and receiver device, video device, camera; memory storage device; bluetooth device; and
The LED light has frames, arms, or housing, the frame, arms, or housing being joined, fixed or held with others frame, arms, or housing or structure to make the LED light has at least one of features including extendable, retractable, movable, changeable, transformable so can change the each frame, arms, or housing relative position, location, orientation of others frame, arms, housing, surface(s) to make proper space for the above electric device(s).
whereby the LED light offers an illumination function from the one of surface and additional functions from the others surface(s).
The said Multiple function LED light is a plug-In outlet and powered by AC power source or Direct current powered unit which has wired, wire & plug, adaptor, transformer which has Direct current power output and into the said Multiple LED light device.
